(19) United States
(12) Patent Application Publication
(10) Pub. No.: US 2006/0290495 A1
(43) Pub. Date: Dec. 28, 2006

(54) Method for registration of security coding

(76) Inventor: Thomas R. Hughes, Charlotte, NC (US)

Correspondence Address: HAMMER & HANF, PC, 3125 SPRINGBANK LANE, SUITE G, CHARLOTTE, NC, 28226, US

(21) Appl. No.: 11/187,445

(22) Filed: Jul. 22, 2005

Related U.S. Application Data
(60) Provisional application No. 60/590,330, filed on Jul. 22, 2004.

(51) Int. Cl. G08B 13/14

(52) U.S. Cl. 340/571

(57) ABSTRACT

A process for registration of a good having a unique code capable of identifying that good by providing a point of purchase registration system consisting of: checking the unique code with a manufacture to verify that it is correct; registering the unique code with a national security agency on a database for a charge from an owner; and registering a name and an address of the owner of the good with the existing national security agency and linking this information to the unique code. Both the unique code and owner information resides in the existing national security agency database and is available to law enforcement officers who recover stolen goods. Recovered stolen goods can be identified by comparing the codes on recovered goods to the security code in the database and when a match is found, and then the name and the address of the owner can be matched up.

### RELATED CASES

This application claims the Priority of the Provisional Application Ser. No. 60/590,330 filed Jul. 22, 2004.

This invention is a method of registering purchased items where a dealer or retailer offers the registration of security coding on a purchased good in order to deter theft and provide additional means for matching up a recovered stolen property with its owner without anti-theft insurance. This registration strategy is for consumers that do not elect to purchase a warranty providing a financial benefit in the event of theft. This will allow a consumer to pay a registration only charge.

### BACKGROUND

A common occurrence after auto theft is the recovery of the stolen vehicles by law enforcement, where the license plate on the vehicle has been changed. These vehicles are usually found to have all the vehicle's identification marks removed. The Vehicle Identification Number (VIN) are completely cut out, the visible VIN and manufacturers labels are removed and the engine number are thoroughly ground off in preparation for new numbers to be attached. A remnant of a manufacturer's VIN label maybe found, but if it has only 4 digits of the VIN, this is not sufficient to enable identification. These vehicles are recovered daily by law enforcement and are subsequently crushed in their pounds to prevent further criminal activity.

Another problem is that consumer items, such as electronics, which may be TVs DVD players, stereos, MP3 players, computers and the like, are sold to consumers but few take the trouble to fill out the warranty information and send that back to the manufacturer. If this is not done then there exists no documented evidence of who these goods belong to. Law enforcement officers may recover many items that have been stolen but without a verifiable recordation of ownership these goods are often put into warehouse and subsequently destroyed as no owner can be identified.

Marking a vehicle or consumer good's parts with traceable numbers deters theft and is highly recommended by law enforcement departments and insurance companies. Even though vehicle manufacturers discretely mark some parts, it doesn't seem to be enough. By permanently installing visible, nationally registered and traceable serial numbers into your vehicle's glass, body components and accessories and you can greatly reduce auto theft and aid in recovery. Vehicle theft is a business and it's just not worth the risk to professional thieves to have one of these.

Therefore there is a need to have a system to register unique identification numbers nationally.

### SUMMARY OF THE INVENTION

A process for registration of a purchased good where the purchased good has a unique code capable of identifying the purchased good affixed to it. A point of purchase registration system is provided which consists of: checking said unique code with a manufacture or a supplier to verify that it is a correct code for the purchased good; registering the unique code with an existing national security agency on an existing national security agency database for a charge from an owner of the purchased good at the point of purchase; and registering a name and an address of the owner of the purchased good with the existing national security agency on the existing national security agency database and linking this information to the unique code. Both the unique code and owner information resides in the existing national security agency database and is available to law enforcement officers who recover stolen goods. Local authorities are able to identify the recovered stolen goods by comparing the unique security codes on recovered stolen goods to the unique security code in the existing national security agency database and when a match is made, the name and the address of the owner can be matched up with recovered stolen good.

### BRIEF DESCRIPTION OF THE DRAWINGS

FIG. 1 is a flowchart showing the procedure to register the good.

FIG. 2 is a flowchart showing the procedure to identify a recovered good using the invented system.

### DESCRIPTION

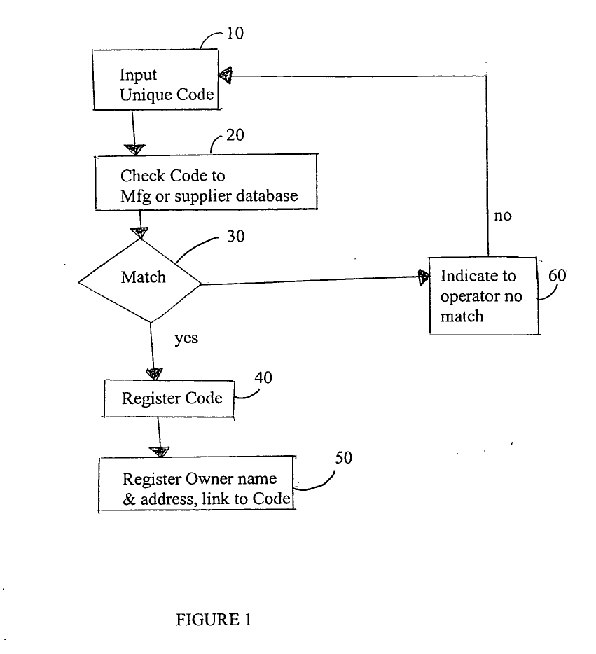

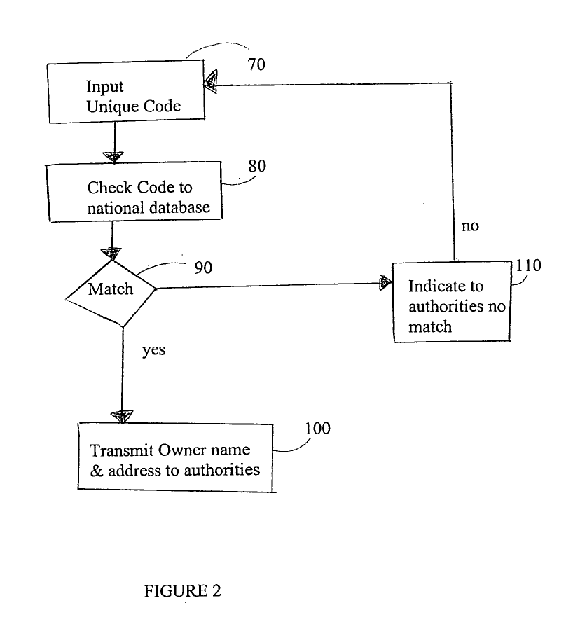

A process for registration of a purchased good where the purchased good has a unique code capable of identifying the purchased good affixed to it. A point of purchase registration system is provided which consists of: inputting said unique code, FIG. 1, 10; checking said unique code with a manufacture or a supplier to verify that it is a correct code for the purchased good 20; registering the unique code with an existing national security agency 40 on an existing national security agency database for a charge or fee from an owner of the purchased good at the point of purchase; and registering a name and an address of the owner 50 of the purchased good with the existing national security agency on the existing national security agency database and linking this information to the unique code. Both the unique code and owner information resides in the existing national security agency database and is available to law enforcement officers who recover stolen goods. Local authorities are able to identify the recovered stolen goods by comparing the unique security codes on recovered stolen goods FIG. 2, 70 to the unique security code in the existing national security agency database 80 and when a match 90 is made, the name and the address of the owner can be matched up with recovered stolen good 100. If no match 90 is made the authorities will be prompted of this 110 and then they will just continue to enter in unique codes 70 until they can make an identification.

This process for registration of the purchased good according may further include the steps of printing up a customer registration certificate to be provided to the owner. It may also include the step of printing up a registration sticker to provide to the owner for notification purposes which can be applied to the owner's purchased good.

The unique code used in this registration process can be selected from the group including: serial numbers, vehicle identification numbers, chassis numbers, phantom foot prints, manufacture identification number, unique identification number or combinations thereof. This system contemplates that unique codes do not have to originate with manufacturer but may be supplied by another supplier or source of security coding.

Examples of such coding include data dots and window etching. DataDots are the size of a grain of sand, each DataDot is laser etched with a Police traceable ID. The DataDots are suspended in a clear drying adhesive and are attached to any item of value, by a spray process or brush on the purchased good. Although the tiny dots are almost invisible to the naked eye, the sprayed area will glow violet when a Black UV light is shone over them, this assists in the early detection that a vehicle has had DataDots applied.

Window etching is a process by which a unique identification number is etched on the windows of a motor vehicle. This number makes the part less attractive to strip from a stolen vehicle for resale. With additional markings on the vehicle it increase the likelihood of identification after it is stolen even if the manufacturer's vehicle identification number is removed from the vehicle after theft.

Additionally there are other registerable identification numbers or codes which can also be used, such as phantom foot prints, or other numbers which come from the manufacturer or are placed on by a dealer which can be registered. Generally these will be a unique number or code other than the Vehicle Identification Number (VIN).

The national agency may be an organization such as the NICB (National Insurance Crime Bureau) through ISO (Insurance Services Office). These national agencies keep databases and will then make the registrations available to law enforcement agency and insurance companies. The national agency may also be another agency similar to the NCIB.

Point of purchase as defined here in this application means the dealership, retail establishment or any other place where a consumer can acquire a purchased good. It is believed that this service is critical at this time because then it will be completed. This is as opposed to the warranty registration cards that are often used to ask marketing questions which the majority of consumers fail to fill out. The problem is that if the serial number of the good is not recorded then law enforcement cannot verify the correct owner and recover goods end up in a warehouse or being destroyed instead of being reunited with their rightful owners. The term point of purchase also contains a time element which is generally within 48 hours of the purchase, often with 24 hours of the purchase and generally contemporaneously, or within 4 hours or less.

In another embodiment of this invention the purchased good is supplied with a plurality of tiny dots all bearing one unique code visible under black ultraviolet (UV) light where the tiny dots are provided by a supplier. The unique code on the dots is what is registered to the existing national security agency database. These tiny dots may be DataDots.

In another embodiment of this invention a second database is provided which is separate from the existing national security agency database. This second database is provided by whoever is running this registration system. This second database keeps a record of the security code and client information which is provided to the existing national security agency database of information. The second database may also store additional information such as the phone number of the owner. It may also record multiple phone numbers for resident, work and cellular numbers as well as E-mail addresses. This second database may also store information such as the location and name of place of the point of purchase sale. The place of the point of purchase may be a dealership, car lot, retail store, warehouse club or any outlet which sales consumer goods to the public. The location may be the city and state or it may include a street address. The second database may also store information of what the purchased good is. If the good is a car it may record the year, manufacturer, model, body style, color, manufacture provided options or any other information which would help to identify the good later on. If it is a consumer electronic good it might also record information such as the year, manufacturer, model, type of good, color and any other relevant information which might prove useful at a later date.

It should be noted that any registration process is only as good as the information which is provided. That is why in the current system the feature of checking with a manufacture or supplier to identify a correct code is so important. During this process of checking if an error is detected then the consumer or owner may be given the option to choose another unit or the place of sale may have an opportunity to correct the mistake. There are multitudes of ways in which the purchased good information may be entered. It may be as simple as inputting a serial number or a vehicle identification number and match that up to a database provided by the manufacturer or information such as what the good is as well as the unique identification code may be inputted. The inputting may be done by the person making the sale by inputting the information into a computer via a keyboard it can be scanned in, inputted by voice recognition, or entered by taking the information of a bar code or some similar information storage means on the purchased good.

After the unique identification code is entered and compared to the code from the database FIG. 1, 30, of the manufacturer or supplier the person making the sale will be prompted that the information is fine and they may proceed or an error code comes up 60. If an error code is detected then the mistake can be handled prior to registration. This will catch mistakes like trying to register multiple people with the same unique code which might happen if the code is keyed in wrong or a mistake occurs during scanning. Also if the unique code is entered in wrong, so that it does not match the number on the purchased goods, it will be no good if the item is stolen and subsequently recovered.

If the system is equipped with the second database this database can make a comparison on all the unique numbers which are inputted and can detect any duplication of unique codes. Further, this second database may be equipped with a means of electronically checking with the manufactures or suppliers database and if given a clear signal it can go on to record the information from the owner. This can be done verbally or electronically. Once this information is stored it can then be transmitted electronically to the existing national security agency database. It should be obvious that if more of the information can be automated that the over all cost of the process can be reduced, this saving can be pasted along to the owner who will be more likely to use the service is the cost is minimal. This second database provides an opportunity to record more information then the existing national security agency database. However, this secondary database can be linked to the existing national security agency database or give information to authorities on how to access this information if additional information is needed.

One example as to how this system may work is that most every new and used car has some type of identification (ID) system such as window etching or DataDots, which are provided by the dealership. Dealers offer security coding with a benefit such as a warranty. The security coding has a unique identification number associated with it. If the customer says no to the benefit, now the dealer will have a second option which is registration. This is important to dealers who sink money into the security coded only to have a loss for people that refuse the benefit. For a charge the dealer will offer to register the security coding only, without providing a benefit of an antitheft warranty. If the customer selects the registration route, he may receive a “Registration Certificate” and window stickers as a notification tool to show that the vehicle has been registered. The vehicle will then be registered with a national agency such as the NICB (National Insurance Crime Bureau) through ISO (Insurance Services Office). These national agencies will then make the registrations available to law enforcement agency and insurance companies. The invented process allows the consumer to register their vehicle with the same systems that a warranty owner gets with the purchase of their protection. This registration system can be offered to both consumers who elect not to purchase warranty protection as well as those consumer purchasing warranty protection. These warranties pay a consumer a benefit if the their vehicle is stolen or if their vehicle is found and is subsequently deemed a total loss. It should be noted that this same system can be used on other insurable property, or consumer goods, other than motor vehicles.

What is claimed is:

1. A process for registration of a purchased good where said purchased good has a unique code capable of identifying said purchased good affixed to the purchased good comprising of the steps of:
providing a point of purchase registration system where said point of purchase registration system comprising:
inputting said unique code;
checking said unique code with a manufacture or a supplier to verify that it is a correct code for the purchased good;
registering said unique code with an existing national security agency on an existing national security agency database for a charge from an owner of said purchased good at said point of purchase; and
registering a name and an address of said owner of said purchased good with said existing national security agency on said existing national security agency database and linking this information to said unique code;
where both said unique code and owner information resides in said existing national security agency database and is available to law enforcement officers who recover stolen goods so that they are able to identify recovered stolen goods by comparing the unique security codes on recovered stolen goods to the unique security code in said existing national security agency database and when a match occurs then the name and the address of said owner can be matched up with recovered stolen good.

2. The process for registration of said purchased good according to claim 1 further comprising the steps of:
printing up a customer registration certificate to be provided to said owner.

3. The process for registration of said purchased good according to claim 1 further comprising the steps of:
printing up a registration sticker to provide to said owner for notification purposes which can be applied to the owner's purchased good.

4. The process for registration of said purchased good according to claim 1 where said unique code is selected from the group consisting of: serial numbers, vehicle identification numbers, chassis numbers, phantom foot prints, manufacture identification number, unique identification number or combinations thereof.

5. The process for registration of said purchased good according to claim 1 where said purchased good is supplied with a plurality of tiny dots all bearing one unique code visible under black ultraviolet (UV) light where said tiny dots are provided by a supplier and registering the one unique code from the supplier to said existing national security agency database.

6. The process for registration of said purchased good according to claim 1 further comprising the steps of:
printing up a customer registration certificate to be provided to said owner; and
printing up a registration sticker to provide to said owner for notification purposes which can be applied to the owner's purchased good.

7. The process for registration of said purchased good according to claim 1 further comprising the steps of:
providing a second database of security code and client information which provides a backup to said existing national security agency database of information provide by said point of purchase registration system.

8. The process for registration of said purchased good according to claim 7 where said second database also store a phone number of said owner.

9. The process for registration of said purchased good according to claim 7 where said second database also store information of location and name of place of the point of purchase sale.

10. The process for registration of said purchased good according to claim 7 where said second database also store information of what the purchased good is.

11. A process for registration of a purchased good where said purchased good has a unique code capable of identifying said purchased good affixed to the purchased good comprising of the steps of:
providing a point of purchase registration system where said point of purchase registration system consists of:
inputting said unique code;
checking said unique code with a manufacture or a supplier to verify that it is a correct code for the purchased good;
registering said unique code with an existing national security agency on an existing national security agency database for a charge from an owner of said purchased good at said point of purchase; and
registering a name and an address of said owner of said purchased good with said existing national security agency on said existing national security agency database and linking this information to said unique code;
inputting said unique code and said name and said address of said owner of said purchased good into a second database which serves as a backup to said existing national security agency database;
where both said unique code and owner information resides in said existing national security agency database and is available to law enforcement officers who recover stolen goods so that they are able to identify recovered stolen goods by comparing the unique security codes on recovered stolen goods to the unique security code in said existing national security agency database and when a match occurs then the name and the address of said owner can be matched up with recovered stolen good.

12. The process for registration of said purchased good according to claim 11 where said second database also store a phone number of said owner.

13. The process for registration of said purchased good according to claim 11 where said second database also store information of location and name of place of the point of purchase sale.

14. The process for registration of said purchased good according to claim 11 where said second database also store information of what said purchased good is.

15. The process for registration of said purchased good according to claim 11 further comprising the steps of:
printing up a customer registration certificate to be provided to said owner; and
printing up a registration sticker to provide to said owner for notification purposes which can be applied to the owner's purchased good.

16. A process for registration of a purchased good where said purchased good has a unique code capable of identifying said purchased good affixed to the purchased good comprising of the steps of:
providing a point of purchase registration system where said point of purchase registration system consists of:
inputting said unique code;
checking said unique code with a manufacture or a supplier to verify that it is a correct code for the purchased good;
registering said unique code with an existing national security agency on an existing national security agency database for a fee from an owner of said purchased good at said point of purchase; and
registering a name and an address of said owner of said purchased good with said existing national security agency on said existing national security agency database and linking this information to said unique code;
inputting said unique code and said name and said address of said owner of said purchased good into a second database which serves as a backup to said existing national security agency database;
printing up a customer registration certificate to be provided to said owner; and
printing up a registration sticker to provide to said owner for notification purposes which can be applied to the owner's purchased good.
where both said unique code and owner information resides in said existing national security agency database and is available to law enforcement officers who recover stolen goods so that they are able to identify recovered stolen goods by comparing the unique security codes on recovered stolen goods to the unique security code in said existing national security agency database and when a match occurs then the name and the address of said owner can be matched up with recovered stolen good.
